(19) United States
(12) Patent Application Publication
(10) Pub. No.: US 2009/0077480 A1
(43) Pub. Date: Mar. 19, 2009

(54) APPARATUS AND METHOD OF MANAGING ELECTRONIC COMMUNITIES OF USERS

(76) Inventors: Mark Leslie CAUNTER, Christchurch (GB); Bruce Kelly JACKSON, Bournemouth (GB); Steven GEACH, Weymouth (GB)

Correspondence Address: QUALCOMM INCORPORATED, 5775 MOREHOUSE DR., SAN DIEGO, CA, 92121, US

(21) Appl. No.: 12/141,682

(22) Filed: Jun. 18, 2008

Related U.S. Application Data
(60) Provisional application No. 60/945,091, filed on Jun. 19, 2007.

(51) Int. Cl. G06F 17/30; G06F 3/048

(52) U.S. Cl. 715/764; 707/102; 707/E17.009

(57) ABSTRACT

Apparatus and methods of discovering and managing electronic communities include placing data tuples into a tuple space, discovering the attributes of the data tuple via a community formation tuple, and generating one or more community tuples based on the discovered relationships.

### CLAIM OF PRIORITY UNDER 35 U.S.C. §119

The present application for patent claims priority to Provisional Application No. 60/945,091 entitled “Apparatus and Method of Managing Communities of Users” filed Jun. 19, 2007, and assigned to the assignee hereof and hereby expressly incorporated by reference herein.

### REFERENCE TO CO-PENDING APPLICATIONS FOR PATENT

The present application for patent is related to the co-pending U.S. patent application Ser. No. ______, entitled “User Interfaces For Service Object Located In A Distributed System” by Jackson et al., having Attorney Docket No. 070833, filed on even date herewith, assigned to the assignee hereof, and expressly incorporated by reference herein, and U.S. patent application Ser. No. ______, entitled “Persistent Personal Messaging in a Distributed System” to Jackson et al., having Attorney Docket No. 072275, filed on even date herewith, assigned to the assignee hereof and hereby expressly incorporated by reference herein.

### BACKGROUND

1. Field

The described aspects relate to electronic and/or on-line communities, and more specifically to apparatus and methods of managing such communities.

2. Background

A distributed computer system, such as but not limited to the Internet, is characterized by rapid, real-time interchange among many dissimilar processes executing simultaneously on a large array of dissimilar and geographically diverse processors. A distributed computer system's resources are usually spatially separated, and the execution of its applications often involves multiple execution threads that can be widely separated in time.

### SUMMARY

The following presents a simplified summary in order to provide a basic understanding of some aspects of the present disclosure. This summary is not an extensive overview and is intended to neither identify key or critical elements nor delineate the scope of such aspects. Its purpose is to present some concepts of the described aspects in a simplified form as a prelude to the more detailed description that is presented later.

In accordance with one or more aspects and corresponding disclosure thereof, various features are described in connection with use of a client device, such as a handheld communication device, to interact with a tuple space distributed computing environment that assists in forming a community of users of such client devices. The tuple space addresses challenges presented by a distributing computing environment.

In one aspect, a method of forming a community of users comprises receiving a plurality of data tuples within a tuple space, wherein each of the plurality of data tuples comprises respective data attributes representing user-related data and a user identifier, and wherein the user-related data and the user identifier both correspond to a respective one of a plurality of users. Further, the method includes monitoring the received plurality of data tuples with a service tuple located within the tuple space, wherein the service tuple comprises at least one service attribute representing a relationship determination algorithm. Further, the method includes discovering, by the service tuple via the relationship determination algorithm, one or more relationships among the respective user-related data. Also, the method includes identifying respective ones of the plurality of users corresponding to each of the identified one or more relationships based on the user identifier corresponding to the respective user-related data associated with the respective relationship. Additionally, the method includes creating and storing within the tuple space, by the service tuple, a community tuple for each of the identified one or more relationships, wherein each community tuple comprises community attributes representing the respective identified relationship and the respective identified ones of the plurality of users of the respective community tuple.

In a related aspect, at least one processor includes one or more modules for implementing the above-noted actions of the method.

In another related aspect, a computer program product comprises a computer readable medium including one or more sets of instructions for causing a computer to carry out the above-noted actions of the method.

In another aspect, an apparatus comprises means for receiving a plurality of data tuples within a tuple space, wherein each of the plurality of data tuples comprises respective data attributes representing user-related data and a user identifier, and wherein the user-related data and the user identifier both correspond to a respective one of a plurality of users. Further, the apparatus includes means for monitoring the received plurality of data tuples, wherein the means for monitoring is located within the tuple space, and wherein the means for monitoring comprises at least one service attribute representing a relationship determination algorithm. Also, the apparatus includes means for discovering, by the means for monitoring via the relationship determination algorithm, one or more relationships among the respective user-related data. Further, the apparatus includes means for identifying respective ones of the plurality of users corresponding to each of the identified one or more relationships based on the user identifier corresponding to the respective user-related data associated with the respective relationship. Additionally, the apparatus includes means for creating and storing within the tuple space a community tuple for each of the identified one or more relationships, wherein each community tuple comprises community attributes representing the respective identified relationship and the respective identified ones of the plurality of users of the respective community tuple.

In yet another aspect, an apparatus comprises a processor and a memory in communication with the processor. Further, the apparatus comprises a community formation module stored in the memory and executable by the processor, wherein the community formation module comprises a tuple space and a service tuple. The tuple space is operable to receive a plurality of data tuples each comprising respective data attributes representing user-related data and a user identifier, wherein the user-related data and the user identifier both correspond to a respective one of a plurality of users. Further, the service tuple comprises at least one service attribute representing a relationship determination algorithm. And, upon execution by the processor, the service tuple is operable to monitor the plurality of data tuples received within the tuple space, discover one or more relationships among the respective user-related data via the relationship determination algorithm, identify respective ones of the plurality of users corresponding to each of the identified one or more relationships based on the user identifier corresponding to the respective user-related data associated with the respective relationship, and create and store within the tuple space a community tuple for each of the identified one or more relationships, and wherein each community tuple comprises community attributes representing the respective identified relationship and the respective identified ones of the plurality of users of the respective community tuple.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects and versions may be employed. Other advantages and novel features will become apparent from the following detailed description when considered in conjunction with the drawings and the disclosed versions are intended to include all such aspects and their equivalents.

### BRIEF DESCRIPTION OF THE DRAWINGS

FIG. 1 is a schematic diagram of one aspect of a system for managing user communities;

FIG. 2 is a schematic diagram of one aspect of a data tuple of FIG. 1;

FIG. 3 is a schematic diagram of one aspect of a community discovery/forming service tuple of FIG. 1;

FIG. 4 is a schematic diagram of one aspect of a community tuple of FIG. 1; and

FIG. 5 is a schematic diagram of one aspect of a communication network operable with the system of FIG. 1.

FIG. 6 is a flow diagram of a methodology for managing user communities, according to one aspect.

### DETAILED DESCRIPTION

The described aspects relate to a user community, such as an on-line or electronic community that communicatively connects users having common interests. For example, such a community includes a website, a chat room, a mail group, an instant messaging group, a virtual meeting group, a text messaging group, a telephonic group call group, a fax group, a blog group, etc. The described aspects, in some cases, provide for the automatic and/or the autonomous discovery and creation of a respective community. Further, the described aspects, in some cases, allow for the discovery and creation of a respective community based on disparate and/or multi-source data. Additionally, the described aspects incorporate a flexible space-based data repository operable to receive data objects representing the data. Thus, the described aspects provide a simple and efficient method and apparatus for discovering, creating, and managing user communities.

In the subject description, the word “exemplary” is used to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

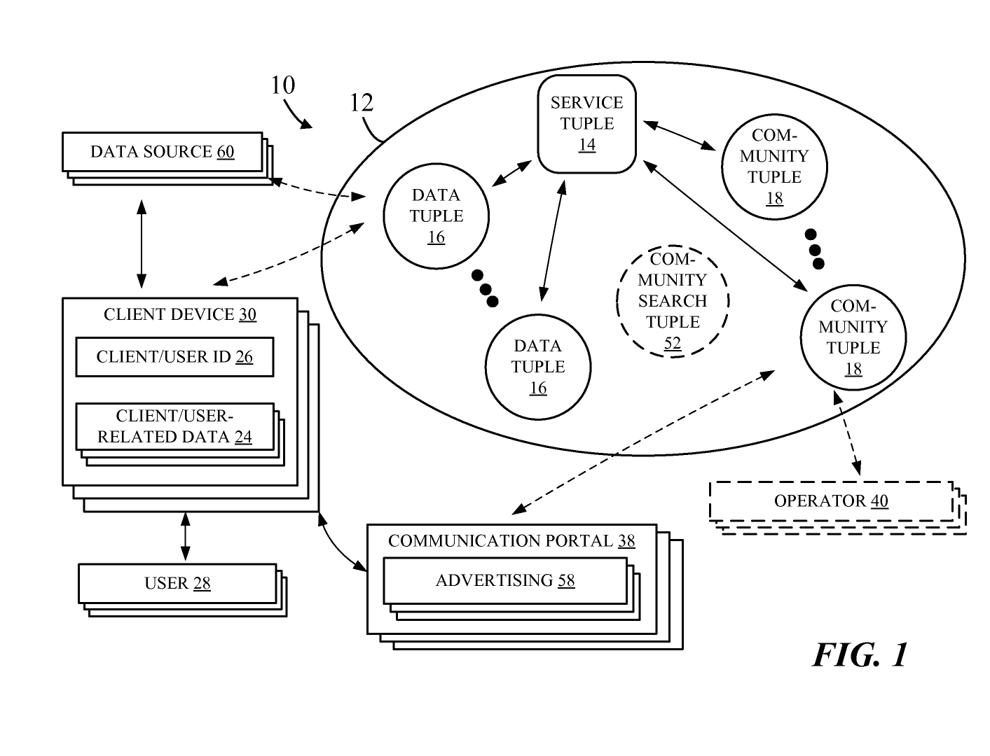

Referring to FIGS. 1-4, a system 10 of creating and managing user communities includes a tuple space 12 having a service tuple 14 operable to evaluate a plurality of data tuples 16 received by tuple space 12 according to one aspect. Service tuple 14 operates to determine if a relationship exists between respective ones of the plurality of data tuples 16, and forms and manages respective community tuples 18 based on discovered relationships.

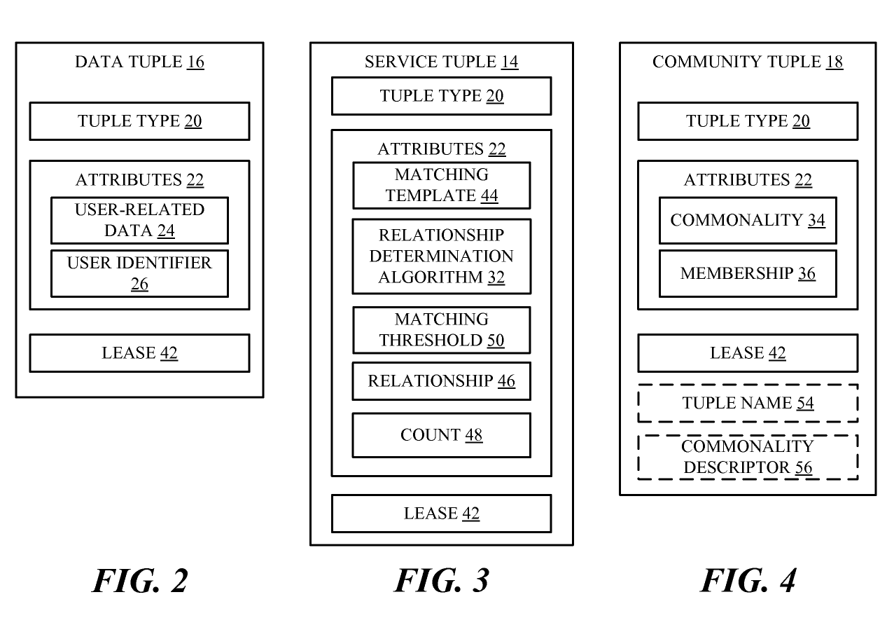

In particular, tuple space 12 comprises a data repository, and each of service tuple 14, data tuple 16, and community tuple 18 comprises an object having an ordered set of data comprising a tuple type 20 and tuple attributes 22. Specifically, tuple type 20 comprises an identifier of the type and/or class of the tuple, such as a service class, a data class, and a community class. Further, tuple attributes 22 may vary depending on tuple type 20. For example, referring to FIG. 2, a tuple object having tuple type 20 corresponding to a data class may have tuple attributes 22 comprising and/or representing user-related data 24 and a user identifier 26, both corresponding to a respective one of a plurality of users 28 (FIG. 1) operating a corresponding client device 30 (FIG. 1) within system 10 (FIG. 1). Similarly, referring to FIG. 3, a tuple object having tuple type 20 corresponding to a service class may have tuple attributes 22 comprising and/or representing a relationship management algorithm 32 operable to determine relationships between data tuples 16 based on user-related data 24 represented by the respective data tuples 16, operable to identify respective ones of the plurality of users 28 of client devices 30 corresponding to each of the identified one or more relationships based on the user identifier 26 corresponding to the respective user-related data 24 associated with the respective relationship, and further operable to create, store and otherwise manage community tuples 18 based on the discovered relationships. Additionally, a tuple object having tuple type 20 corresponding to a community class may have tuple attributes 22 comprising and/or representing a commonality 34, such as the discovered relationship forming the basis of the respective community tuple 18, and a membership 36, such as a set of the respective identified users 28 of client devices 30 associated with the respective community tuple 18.

Further, community tuples 18 may be discovered by each of the plurality of users 28 through interaction of the corresponding client device 30 with tuple space 12, whereby each respective user 28 may join an interactive community of users defined by the respective community tuple 18, for example, via a respective community portal 38. For example, the interaction resulting in the discovery of a respective community tuple 18 may include a search for community tuples 18 initiated by client device 30, and/or receipt of a message, generated by service tuple 14 and/or community tuple 18 and/or an operator 40 of system 10, wherein the message informs the respective client device 30, and hence the respective user 28, of the relationship to the user community defined by the respective community tuple 18. As such, a respective user 28 is able to accept or refuse participation in an on-line and/or electronic user community potentially of interest to the respective user 28 based on commonality 34 defined by the discovered relationship between corresponding user-related data 24.

Thus, system 10 enables the discovery, creation and management of user communities based on relationships between data tuples 16 received by tuple space 12.

A “tuple space” is a globally shared, associatively addressed memory space that is organized as a grouping of tuples. A “tuple” is the basic element of a tuple space system. In the context of a tuple space based coordination language like Linda, a tuple is a vector having fields or values of certain types. In a broader sense, a “tuple” is an entry in an information storage system. For example, a row in a relational database system can be referred to as a tuple.

In Linda-like languages, constructs called “templates” are used to associatively address tuples via matching techniques. A template matches a tuple if they have an equal number of fields and if each template field matches the corresponding tuple field.

Tuple space based coordination languages provide a simple yet powerful mechanism for inter-process communication and synchronization, which is the crux of parallel and distributed programming. A process with data to share generates a tuple and places it into the tuple space. A process requiring data simply requests a tuple from the tuple space.

Tuple space programs may be easier to write and maintain for a number of reasons including the following:

(1) Destination uncoupling (fully anonymous communication)—the creator of a tuple requires no knowledge about the future use of that tuple or its destination.

(2) Spatial uncoupling—because tuples are retrieved using an associative addressing scheme, multiple address-space-disjoint processes can access tuples in the same way.

(3) Temporal uncoupling—tuples have their own life span, independent of the processes that generated them or any processes that may read them. This enables time-disjoint processes to communicate seamlessly.

Tuple space based coordination languages can provide the essential features (spatial and temporal separation) required for many different types of distributed applications, especially for use over the Internet. Developed by scientists and academicians, the Internet was originally used to share research information and to collaborate. However, the Internet now encompasses millions of world-wide computers networked together.

There are two distinct types of implementations of tuple space based coordination languages (e.g. Linda), characterized as being either “closed” or “open.” The closed implementations use compile time analysis of object and source code to provide highly efficient closed programs. The open implementations allow processes, agents, and programs to coordinate through tuple spaces without the run-time system requiring any prior knowledge. Essentially, the open implementations provide a persistent data store.

The Linda language uses three standard instructions or primitives. These are (with their informal semantics):

(1) out(tuple) Insert a tuple into a tuple space.

(2) in(template) If a tuple exists that matches the template, then remove the tuple and return it to the agent performing the in. If no matching tuple is available, then the primitive blocks until a matching tuple is available.

(3) rd(template) If a tuple exists that matches the template, then return a copy of the tuple to the agent that performed the rd. If there is no matching tuple, then the primitive blocks until a matching tuple is available.

Referring back to FIG. 1, tuple space 12 comprises an abstract space operable to receive data objects, e.g. tuples 14, 16 and 18, and includes a predetermined set of operations that can be performed within the space. For example, the predetermined set of functions may include an “in” function and a “rd” function, which both take input parameters that allow the selection of specific tuples in the space by matching the input parameters, where given, with those values present within the tuple space. Additionally, both the “in” and “rd” functions may have non-blocking equivalents (inp and rdp). In some aspects, the predetermined set of functions may include a set of operations, such as JAVA methods, that may be performed on both tuple space 12 and tuples 14, 16, and 18.

Further, in a specific example, each tuple 14, 16 and 18 is an instance of a com.qualcomm.qspaces.linda.Tuple class or subclass, and is created with a set of attributes 22, defined by an array of objects which are specified when the tuple is constructed. The array can be zero-length, however, in some aspects, the array may not be null. In addition, in some aspects, none of the individual attribute objects in the array may be null.

In some aspects, when the respective tuple 14, 16, and 18 is first constructed, and every time the respective attributes 22 are retrieved from the respective tuple, the array of objects may be defensively copied using a very fast form of in-memory serialization. This process allows the respective tuple 14, 16 and 18 to be immutable, and therefore, guarantees the integrity of tuple space 12 in which the respective tuple 14, 16, and 18 resides.

In the above-noted aspects, tuple equality adheres to the same equality principles of any JAVA object, including the symmetry rule which states that if t1.equals(t2) then t2.equals(t1).

Specifically, a tuple equals another tuple, e.g. t1.equals(t2), if t2, known as a template, meets the following criteria:

1) The class 20 of the template t2 is the same class 20 as the tuple t1.

2) The attributes 22 of the template t2 are equal to the attributes 22 of the tuple t1, meaning that t2's attributes 22 are the same as t1's attributes 22, irrespective of their order.

In other aspects, a tuple matches another tuple, e.g. t1.matches(t2), if t2, known as a template, meets the following criteria:

1) The class 20 of the template t2 is the same class 20 or a super class of the tuple t1.

2) The attributes 22 of the template t2 match the attributes 22 of the tuple t1, meaning that t2's attributes 22 are the same set or a subset of t1's attributes 22, irrespective of their order.

When matching one tuple with another, the symmetry rule does not apply; so, t1.matches(t2) does not necessarily equate to t2.matches(t1).

In some aspects, the comparison of one set of tuple attributes 22 with another uses the normal object equality rules, so any object used as a tuple attribute 22 must correctly implement the object.equals(Object obj) and object.hashcode( ) methods.

A respective tuple 14, 16, or 18 is added to tuple space 12 with a lease 42 (FIGS. 2-4). Lease 42 is a period of time, for example specified in milliseconds, which defines how long the tuple will remain in the respective tuple space 12. For example, lease 42 having a value of zero may indicate that the respective tuple never expires. Once lease 42 has expired for a respective tuple, the tuple is automatically removed from tuple space 12.

Service tuples 14 represent services that interact with by clients of the tuple space 12, such as client devices 30. Further, service tuples 14 are also autonomous “live” JAVA objects in their own right, which may also interact with tuple space 12 and other tuples in the space. Service tuples 14 may be discovered in the same manner as other tuples, e.g. by matching the class 20 and attributes 22 of the tuple. In some aspects, service tuples 14 may not be used in this way, however, rather service tuples 14 are interacted with indirectly by placing other tuples, such as data tuples 16, into tuple space 12.

For example, a client, such as a respective client device 30, may create data tuple 16 of class A with attributes abc and 123, and places the tuple into tuple space 12. As such, data tuple 16 can be described using the following notation:

(A, “abc”, 123).

As described previously, service tuple 14 is a live object which can interact with tuple space 12 in the same way as a client application. As such, in this example, service tuple 14 has been instantiated and is blocking on a read from tuple space 12 for any tuples with a matching template 44 for class A and any attributes. Such a matching criterion can be described as follows:

(A, ?s, ?x)

where ?s and ?x mean that any values of the string s and the integer x will be matched. Consequently, tuple space 12 matches the template from service tuple 14, and will then read tuple A from tuple space 12. In this manner, the described aspects pass parameters in the form of tuples to a service.

More specifically, in the described aspects, service tuple 14 (FIG. 3) includes matching template 44 that monitors tuple space 12 for any tuples having tuple type 20 corresponding to a data class, thereby identifying data tuples 16. Further, matching template 44 allows for identified data tuples 16 to have any attributes 22, thereby causing service tuple 14 to read all user-related data 24 and corresponding user identifiers 26 into relationship determination algorithm 32. Relationship determination algorithm 32 thereby operates to identify and store relationships 46 between user-related data 24, and further operates to track a count 48 of unique corresponding user identifiers 26. Upon count 48 achieving a predetermined matching threshold 50, such as a minimum number of unique user identifiers 26 considered worthwhile for forming a community, relationship determination algorithm 32 creates a respective community tuple 18 and places the community tuple 18 in tuple space 12. For example, predetermined matching threshold 50 may be defined by operator 40 of tuple space 12.

As noted above, and as with any other tuple in tuple space 12, community tuple 18 may be discovered by placing within tuple space 12 another tuple having a template defining a community class tuple and any attributes. For example, in system 10, operator 40, a respective client device 30, and/or any other party operating within system 10 may place such a community search tuple 52 (FIG. 1), having the above-stated community matching criteria, within tuple space 12 to discover community tuples 18. In particular, community search tuple 52 is a type of service tuple representing a community search service constructed to match and read community type tuples placed into tuple space 12. As such, operator 40, a respective client device 30, and/or any other party operating within system 10 may read community tuples 18 within tuple space 12, and extract the corresponding attributes 22, such as commonality 34 and membership 36, thereby enabling a party to contact the corresponding users 30 based on user identifiers 26. Further, the party may further provide a tuple name 54 and/or a commonality descriptor 56 for one or more respective community tuples 18 in order to make reference to the respective tuple more user friendly. For example, tuple name 54 may generally identify the respective community tuple 18, and commonality descriptor 56 may provide a definition or explanation of the discovered relationship(s) that form commonality 34.

Further, operator 40, a respective client device 30, and/or any other party operating within system 10 may define a respective communications portal 38 operable to enable communications between respective users 30 having membership 36 in the respective community represented by community tuple 18. For example, communications portal 38 may include a website, an email client, an instant messaging client, a short message service client, etc.

Additionally, since commonality 34 of a given community represented by a respective community tuple 18 may be discovered, communication portal 38 may include advertising 58, and more specifically, directed advertising aimed at matching one or more interests of the corresponding community of users and based on commonality 34.

Further, in system 10, it is possible to embed objects that represent user interfaces into the service objects themselves. Indeed, several user interface objects of different types may be placed into a single service object.

Consider the following user interface service tuple:

(A, [Java], [Flash], [uiOne])

This user interface service tuple, A, contains 3 user interface objects, defined in JAVA, ADOBE Flash and uiOne™ technologies developed by QUALCOMM Incorporated of San Diego, Calif. In the context of mobility, the present aspects enable the offering of a service across a wide variety of wireless devices, each with its own specific requirements, whether in terms of support of different technologies such as Java, Flash or uiOne, or even multiple variants of a single technology, optionally including optimizations for screen size or other device-specific properties.

A respective client device (and corresponding application) 30, operator 40, and/or any other party to system 10, is thus able to locate a user interface service object and then load user interface components from it, for example, in order to communicate according to the given parameters of a respective communication portal 38.

Referring back to FIG. 1, data tuples 16 may be placed into tuple space 12 either directly by a respective client device 30, such as a wireless device, or alternately by a data source 60, such as a service with which client device interacts, or a service connected to the service interacting with client device. For example, client device 30 may be any type of computerized wireless device, such as a cellular telephone, a satellite telephone, a PDA, a laptop computer, etc. Further, data source 60 may comprise a transactional service, such as an Internet- or web-based commercial establishment operable to sell goods and/or services. As such, data tuples 16 may represent such transactions between one or more client devices 30 and one or more transactional services. In this manner, data tuples 16 may be placed into tuple space 12 from a wide variety of data sources 60, such as from generally non-related services, and user communities may be discovered from the wide variety of data, which may have been previously considered to be unrelated. Thus, system 10 allows for the discovery of new relationships based on any combination of data.

In one aspect, system 10 may be implemented in a communications network that includes a cellular phone network.

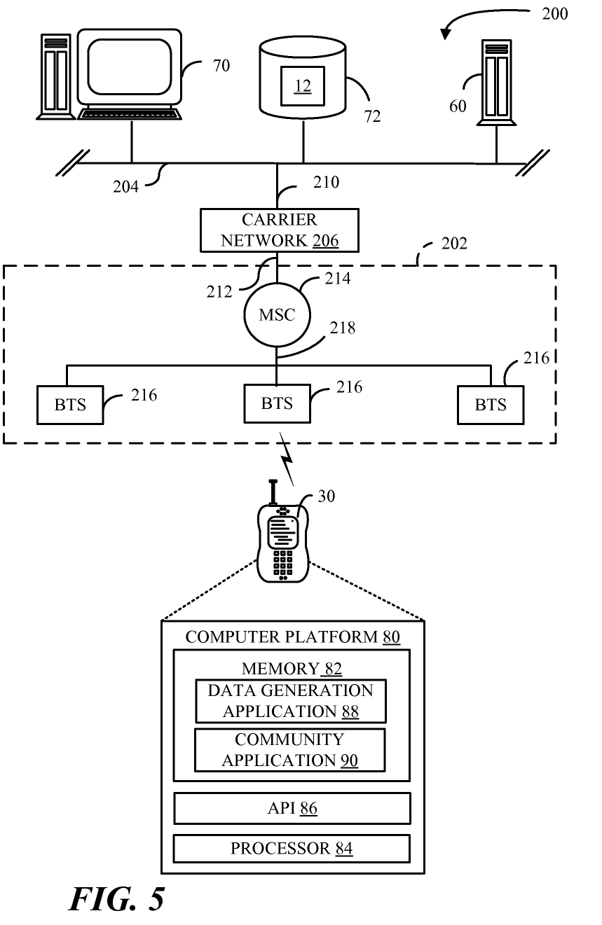

Referring to FIG. 5, for example, a communications network 200 includes one or a plurality of client devices 30, wireless telephone devices in this case, utilizes a wireless network 202 to communicate with wired network 204 (e.g. a local area network, LAN, etc.) having network device or server 70 and/or storage device 72 and/or data source 60. One or both of network device/server 70 and/or storage device 72 may include tuple space 12 and some portions the above-discussed components of system 10. Further data source 60 may include a processor and a memory in communication with the processor, wherein the memory comprises a tuple generation module having tuple generation logic operable to generate a plurality of data tuples from any source of data operable to determine user communities, such as a web-based transactional service. In particular, wireless device 30 includes a computer platform 80 having a memory 82 in communication with a processor 84, such as via an application programming interface (API) 86 that enables interaction with any resident applications, such as a data generation application 88 that generates user-related data and a user identifier, and a community application 90 that enables community based communication exchanges. Further, network device or server 70 and/or storage device 72 and/or data source 60 may include a processor and a memory in communication with the processor, as well as a community formation module stored in the memory and executable by the processor, wherein the community formation module comprises tuple space 12 and service tuple 14, described above. Wireless network 202 is connected to wired network 204 via a carrier network 206. It should be noted that FIG. 5 is a representative diagram that more fully illustrates the components of a wireless communication network and the interrelation of the elements of one aspect of the present system. Communications network 200 is merely exemplary and can include any system whereby remote modules, such as wireless communication devices 30, communicate over-the-air between and among each other and/or between and among other components of a wireless and/or wired network, including, without limitation, wireless network carriers, and/or servers.

Network device or server 70 and/or storage device 72 and/or data source 60 may be present on communications network 200 with any other network components that are desired to provide community management capabilities and/or cellular telecommunication services. Network device or server 70 and/or storage device 72 and/or data source 60 may communicate with carrier network 206 through a data links 210 and 212, which may be data links such as the Internet, a secure LAN, WAN, or other network. Carrier network 206 controls messages (generally being data packets) sent to a mobile switching center (MSC) 214. Further, carrier network 206 communicates with MSC 214 by a network 212, such as the Internet, and/or POTS (plain old telephone service). For example, in network 212, a network, or Internet portion transfers data, and the POTS portion transfers voice information. MSC 214 may be connected to multiple base stations (BTS) 216 by another network 218, such as a data network and/or Internet portion for data transfer and a POTS portion for voice information. BTS 216 ultimately broadcasts messages wirelessly to the wireless communication devices 30, for example using predetermined voice and/or data packet services, such as Code Division Multiple Access (CDMA) and short messaging service (SMS), respectively, or any other over-the-air methods.

Thus, communication network 200, in combination with system 10, allow for the discovery, creation and management of electronic or on-line user communities based on relationships discovered between data objects in a tuple space. Further, communication network 200, in combination with system 10, allow for interaction among the identified users of a respective user community.

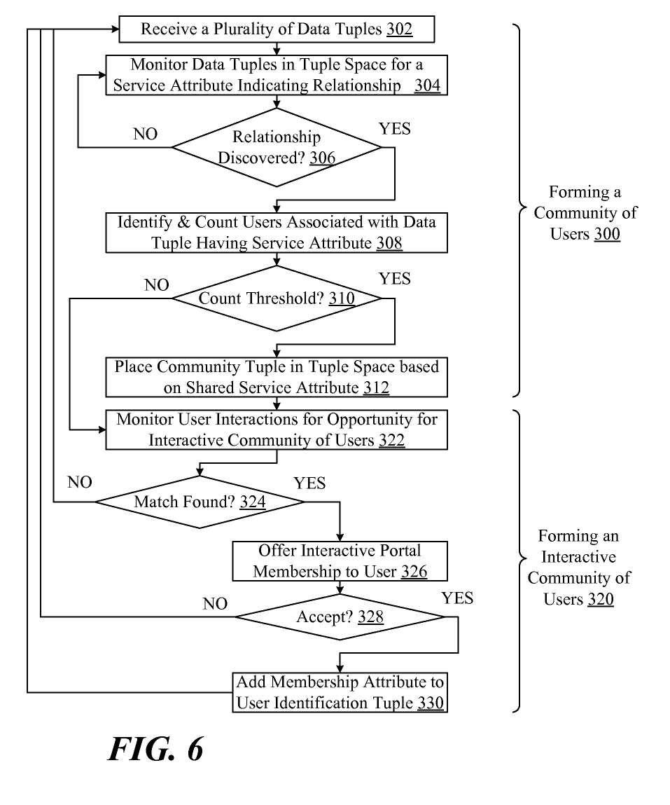

In FIG. 6, an illustrative methodology for forming a community of users, depicted at 300 includes receiving a plurality of data tuples at block 302. The data tuples in tuple space are monitored for a service attribute that indicates a relationship in block 304. Once a relationship is discovered in block 306, then identified users are associated with a data tuple having the service attribute in block 308 and the number of such identified users are counted. If the count exceeds a count threshold in block 310, then a community tuple is placed in tuple space in block 312.

FIG. 6 also depicts a methodology for forming an interactive community of users, depicted at block 320. User interactions are monitored for opportunities for an interactive community of users at block 322. Once a match is found in block 324, then the user is offered a membership in an interactive portal on block 326. If the user accepts in block 328, then a membership attribute is added to a user identification tuple in block 330.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

While the foregoing disclosure discusses illustrative aspects, it should be noted that various changes and modifications could be made herein without departing from the scope of the described aspects as defined by the appended claims. Furthermore, although elements of the described aspects may be described or claimed in the singular, the plural is contemplated unless limitation to the singular is explicitly stated. Additionally, all or a portion of any aspect may be utilized with all or a portion of any other aspect, unless stated otherwise.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method of forming a community of users, comprising:
receiving a plurality of data tuples within a tuple space, wherein each of the plurality of data tuples comprises respective data attributes representing user-related data and a user identifier, wherein the user-related data and the user identifier both correspond to a respective one of a plurality of users;
monitoring the received plurality of data tuples with a service tuple located within the tuple space, wherein the service tuple comprises at least one service attribute representing a relationship determination algorithm;
discovering, by the service tuple via the relationship determination algorithm, one or more relationships among the respective user-related data;
identifying respective ones of the plurality of users corresponding to each of the identified one or more relationships based on the user identifier corresponding to the respective user-related data associated with the respective relationship; and
creating and storing within the tuple space, by the service tuple, a community tuple for each of the identified one or more relationships, wherein each community tuple comprises community attributes representing the respective identified relationship and the respective identified ones of the plurality of users of the respective community tuple.

2. The method of claim 1, further comprising, for a respective community tuple, adding an additional user to the respective identified ones of the plurality of users based on receiving an additional data tuple within the tuple space, wherein the additional data tuple comprises additional data attributes representing additional user-related data and an additional user identifier both corresponding to the additional user, and wherein the additional user-related data corresponds to the respective identified relationship of the respective community tuple.

3. The method of claim 1, further comprising counting the identified ones of the plurality of users corresponding to each respective identified relationship, and determining if the respective count meets a predetermined count threshold, wherein the creating and the storing occurs if the respective count is determined to meet the predetermined count threshold.

4. The method of claim 1, wherein the plurality of data tuples comprise a predetermined tuple type, and further comprising automatically initiating the monitoring and discovering upon the receiving of the plurality of data tuples within the tuple space based on the predetermined tuple type.

5. The method of claim 1, further comprising automatically initiating the monitoring, discovering, identifying, creating and storing upon the receiving of the plurality of data tuples within the tuple space if the plurality of data tuples comprise a predetermined tuple type corresponding to a data type.

6. The method of claim 1, further comprising, for at least one respective community tuple, defining a portal operable to connect the respective identified ones of the plurality of users of the respective community tuple.

7. The method of claim 6, further comprising receiving a portal-specific interactive user interface operable by the respective identified ones of the plurality of users of the respective community tuple.

8. The method of claim 7, further comprising receiving advertising directed to at least one respective portal-specific interactive user interface.

9. The method of claim 6, further comprising receiving a user interface object within the tuple space, wherein the user interface object represents a selectable plurality of types of user interface technology operable for interaction with a respective community tuple.

10. The method of claim 1, further comprising inviting the respective identified ones of the plurality of users of each respective community tuple to join an interactive community.

11. The method of claim 1, wherein receiving the plurality of data tuples further comprises receiving respective transactional data corresponding to a respective transaction performed by the respective user.

12. The method of claim 1, wherein receiving the plurality of data tuples further comprises receiving respective data based on a respective wireless device interaction with a respective wireless device service.

13. The method of claim 1, wherein receiving the plurality of data tuples further comprises receiving data objects having a common object type from multiple data sources.

14. The method of claim 1, further comprising, for at least one respective community tuple, receiving at least one of a community tuple name and a commonality descriptor associated with the respective identified relationship.

15. At least one processor configured to form a community of users, comprising:
a first module for receiving a plurality of data tuples within a tuple space, wherein each of the plurality of data tuples comprises respective data attributes representing user-related data and a user identifier, wherein the user-related data and the user identifier both correspond to a respective one of a plurality of users;
a second module for monitoring the received plurality of data tuples, wherein the second module comprises a service tuple located within the tuple space, wherein the service tuple comprises at least one service attribute representing a relationship determination algorithm;
a third module for discovering, by the service tuple via the relationship determination algorithm, one or more relationships among the respective user-related data;
a fourth module for identifying respective ones of the plurality of users corresponding to each of the identified one or more relationships based on the user identifier corresponding to the respective user-related data associated with the respective relationship; and
a fifth module for creating and storing within the tuple space, by the service tuple, a community tuple for each of the identified one or more relationships, wherein each community tuple comprises community attributes representing the respective identified relationship and the respective identified ones of the plurality of users of the respective community tuple.

16. A computer program product, comprising:
a computer-readable medium comprising:
at least one instruction for causing a computer to receive a plurality of data tuples within a tuple space, wherein each of the plurality of data tuples comprises respective data attributes representing user-related data and a user identifier, wherein the user-related data and the user identifier both correspond to a respective one of a plurality of users;
at least one instruction for causing the computer to monitor the received plurality of data tuples, wherein the at least one instruction comprises a service tuple located within the tuple space, wherein the service tuple comprises at least one service attribute representing a relationship determination algorithm;
at least one instruction for causing the computer to discover, by the service tuple via the relationship determination algorithm, one or more relationships among the respective user-related data;
at least one instruction for causing the computer to identify respective ones of the plurality of users corresponding to each of the identified one or more relationships based on the user identifier corresponding to the respective user-related data associated with the respective relationship; and
at least one instruction for causing the computer to create and store within the tuple space, by the service tuple, a community tuple for each of the identified one or more relationships, wherein each community tuple comprises community attributes representing the respective identified relationship and the respective identified ones of the plurality of users of the respective community tuple.

17. An apparatus, comprising:
means for receiving a plurality of data tuples within a tuple space, wherein each of the plurality of data tuples comprises respective data attributes representing user-related data and a user identifier, wherein the user-related data and the user identifier both correspond to a respective one of a plurality of users;
means for monitoring the received plurality of data tuples, wherein the means for monitoring is located within the tuple space, wherein the means for monitoring comprises at least one service attribute representing a relationship determination algorithm;
means for discovering, by the means for monitoring via the relationship determination algorithm, one or more relationships among the respective user-related data;
means for identifying respective ones of the plurality of users corresponding to each of the identified one or more relationships based on the user identifier corresponding to the respective user-related data associated with the respective relationship; and
means for creating and storing within the tuple space a community tuple for each of the identified one or more relationships, wherein each community tuple comprises community attributes representing the respective identified relationship and the respective identified ones of the plurality of users of the respective community tuple.

18. An apparatus, comprising:
a processor;
a memory in communication with the processor;
a community formation module stored in the memory and executable by the processor, wherein the community formation module comprises a tuple space and a service tuple;
wherein the tuple space is operable to receive a plurality of data tuples each comprising respective data attributes representing user-related data and a user identifier, wherein the user-related data and the user identifier both correspond to a respective one of a plurality of users;
wherein the service tuple comprises at least one service attribute representing a relationship determination algorithm; and
wherein, upon execution by the processor, the service tuple is operable to monitor the plurality of data tuples received within the tuple space, discover one or more relationships among the respective user-related data via the relationship determination algorithm, identify respective ones of the plurality of users corresponding to each of the identified one or more relationships based on the user identifier corresponding to the respective user-related data associated with the respective relationship, and create and store within the tuple space a community tuple for each of the identified one or more relationships, wherein each community tuple comprises community attributes representing the respective identified relationship and the respective identified ones of the plurality of users of the respective community tuple.

19. The apparatus of claim 18, wherein the community formation module, for a respective community tuple, is further operable to add an additional user to the respective identified ones of the plurality of users based on receiving an additional data tuple within the tuple space, wherein the additional data tuple comprises additional data attributes representing additional user-related data and an additional user identifier both corresponding to the additional user, and wherein the additional user-related data corresponds to the respective identified relationship of the respective community tuple.

20. The apparatus of claim 18, wherein the community formation module is further operable to count the identified ones of the plurality of users corresponding to each respective identified relationship, and determine if the respective count meets a predetermined count threshold, wherein the community formation module is further operable to perform the creating and the storing of each respective community tuple if the respective count is determined to meet the predetermined count threshold.

21. The apparatus of claim 18, wherein the plurality of data tuples comprise a predetermined tuple type, and wherein the community formation module is further operable to automatically initiate the monitoring and the discovering upon the receiving of the plurality of data tuples within the tuple space based on the predetermined tuple type.

22. The apparatus of claim 18, wherein the community formation module is further operable to automatically initiate the monitoring, discovering, identifying, creating and storing upon the receiving of the plurality of data tuples within the tuple space if the plurality of data tuples comprises a predetermined tuple type corresponding to a data type.

23. The apparatus of claim 18, wherein the community formation module is further operable to define, for at least one respective community tuple, a portal operable to connect the respective identified ones of the plurality of users of the respective community tuple.

24. The apparatus of claim 23, wherein the community formation module is further operable to receive a portal-specific interactive user interface operable by the respective identified ones of the plurality of users of the respective community tuple.

25. The apparatus of claim 24, wherein the community formation module is further operable to receive advertising directed to at least one respective portal-specific interactive user interface.

26. The apparatus of claim 23, wherein the community formation module is further operable to receive a user interface object within the tuple space, wherein the user interface object represents a selectable plurality of types of user interface technology operable for interaction with a respective community tuple.

27. The apparatus of claim 18, wherein the community formation module is further operable to generate an invitation to the respective identified ones of the plurality of users of each respective community tuple to join an interactive community.

28. The apparatus of claim 18, wherein the plurality of data tuples further comprise respective transactional data corresponding to a respective transaction performed by the respective user.

29. The apparatus of claim 18, wherein the plurality of data tuples further comprise respective data based on a respective wireless device interaction with a respective wireless device service.

30. The apparatus of claim 18, wherein the plurality of data tuples further comprise data objects having a common object type from multiple data sources.

31. The apparatus of claim 18, wherein at least one respective community tuple further comprises at least one of a community tuple name and a commonality descriptor associated with the respective identified relationship.

32. A method of providing data for forming a community of users, comprising:
generating a plurality of data tuples each comprising respective data attributes representing user-related data and a user identifier, wherein the user-related data and the user identifier both correspond to a respective one of a plurality of users; and
forwarding the plurality of data tuples to a tuple space operable to:
monitor the received plurality of data tuples with a service tuple located within the tuple space, wherein the service tuple comprises at least one service attribute representing a relationship determination algorithm;
discover, by the service tuple via the relationship determination algorithm, one or more relationships among the respective user-related data;
identify respective ones of the plurality of users corresponding to each of the identified one or more relationships based on the user identifier corresponding to the respective user-related data associated with the respective relationship; and
create and store within the tuple space, by the service tuple, a community tuple for each of the identified one or more relationships, wherein each community tuple comprises community attributes representing the respective identified relationship and the respective identified ones of the plurality of users of the respective community tuple.

33. The method of claim 32, wherein generating the plurality of data tuples further comprises receiving respective transactional data corresponding to a respective transaction performed by the respective user.

34. The method of claim 32, wherein generating the plurality of data tuples further comprises receiving respective data based on a respective wireless device interaction with a respective wireless device service.

35. The method of claim 32, wherein generating the plurality of data tuples further comprises generating data objects having a common object type based on data received from multiple data sources.

36. At least one processor configured to provide data for forming a community of users, comprising:
a first module for generating a plurality of data tuples each comprising respective data attributes representing user-related data and a user identifier, wherein the user-related data and the user identifier both correspond to a respective one of a plurality of users; and
a second module for forwarding the plurality of data tuples to a tuple space operable to:
monitor the received plurality of data tuples with a service tuple located within the tuple space, wherein the service tuple comprises at least one service attribute representing a relationship determination algorithm;
discover, by the service tuple via the relationship determination algorithm, one or more relationships among the respective user-related data;
identify respective ones of the plurality of users corresponding to each of the identified one or more relationships based on the user identifier corresponding to the respective user-related data associated with the respective relationship; and
create and store within the tuple space, by the service tuple, a community tuple for each of the identified one or more relationships, wherein each community tuple comprises community attributes representing the respective identified relationship and the respective identified ones of the plurality of users of the respective community tuple.

37. A computer program product, comprising:
a computer-readable medium comprising:
at least one instruction for causing a computer to generate a plurality of data tuples each comprising respective data attributes representing user-related data and a user identifier, wherein the user-related data and the user identifier both correspond to a respective one of a plurality of users; and
at least one instruction for causing the computer to forward the plurality of data tuples to a tuple space operable to:
monitor the received plurality of data tuples with a service tuple located within the tuple space, wherein the service tuple comprises at least one service attribute representing a relationship determination algorithm;
discover, by the service tuple via the relationship determination algorithm, one or more relationships among the respective user-related data;
identify respective ones of the plurality of users corresponding to each of the identified one or more relationships based on the user identifier corresponding to the respective user-related data associated with the respective relationship; and
create and store within the tuple space, by the service tuple, a community tuple for each of the identified one or more relationships, wherein each community tuple comprises community attributes representing the respective identified relationship and the respective identified ones of the plurality of users of the respective community tuple.

38. An apparatus, comprising:
means for generating a plurality of data tuples each comprising respective data attributes representing user-related data and a user identifier, wherein the user-related data and the user identifier both correspond to a respective one of a plurality of users; and
means for forwarding the plurality of data tuples to a tuple space operable to:
monitor the received plurality of data tuples with a service tuple located within the tuple space, wherein the service tuple comprises at least one service attribute representing a relationship determination algorithm;
discover, by the service tuple via the relationship determination algorithm, one or more relationships among the respective user-related data;
identify respective ones of the plurality of users corresponding to each of the identified one or more relationships based on the user identifier corresponding to the respective user-related data associated with the respective relationship; and
create and store within the tuple space, by the service tuple, a community tuple for each of the identified one or more relationships, wherein each community tuple comprises community attributes representing the respective identified relationship and the respective identified ones of the plurality of users of the respective community tuple.

39. A network device for providing data for forming a community of users, comprising:
a processor;
a memory in communication with the processor;
wherein the memory comprises a tuple generation module having tuple generation logic operable to generate a plurality of data tuples each comprising respective data attributes representing user-related data and a user identifier, wherein the user-related data and the user identifier both correspond to a respective one of a plurality of users, and further operable to forward the plurality of data tuples to a tuple space operable to:
monitor the received plurality of data tuples with a service tuple located within the tuple space, wherein the service tuple comprises at least one service attribute representing a relationship determination algorithm;
discover, by the service tuple via the relationship determination algorithm, one or more relationships among the respective user-related data;
identify respective ones of the plurality of users corresponding to each of the identified one or more relationships based on the user identifier corresponding to the respective user-related data associated with the respective relationship; and
create and store within the tuple space, by the service tuple, a community tuple for each of the identified one or more relationships, wherein each community tuple comprises community attributes representing the respective identified relationship and the respective identified ones of the plurality of users of the respective community tuple.

40. The network device of claim 39, wherein the plurality of data tuples comprise respective transactional data corresponding to a respective transaction performed by the respective user.

41. The network device of claim 39, wherein the plurality of data tuples comprise respective wireless device interaction data based on a respective wireless device interaction with a respective wireless device service.

42. The network device of claim 39, wherein the plurality of data tuples further comprise data objects having a common object type based on data received from multiple data sources.

43. A method of enabling participation in a community of users, comprising:
causing generation of data operable to comprise at least one data tuple, wherein each data tuple comprises respective data attributes representing user-related data and a user identifier, wherein the user-related data and the user identifier both correspond to a respective user;
receiving an indication of being a member of a community of users, wherein the indication is based on receipt of the at least one data tuple by a tuple space and discovery of a relationship between the at least one data tuple and other data tuples within the tuple space, wherein the other data tuples comprise respective data attributes representing respective user-related data and respective user identifiers corresponding to respective other users, wherein the relationship is discovered by a service tuple located within the tuple space and having a relationship determination algorithm; and
generating a response to the indication, wherein the response comprises an acceptance or a refusal to join the community of users.

44. The method of claim 43, further comprising receiving a definition of a portal operable to connect members of the community.

45. The method of claim 44, further comprising receiving a portal-specific interactive user interface operable to connect members of the community.

46. The method of claim 45, further comprising receiving advertising directed to the portal-specific interactive user interface.

47. The method of claim 43, further comprising accessing a user interface object within the tuple space, wherein the user interface object represents a selectable plurality of types of user interface technology operable for interaction with the community, and obtaining a selected one of the plurality of types of user interface technology.

48. The method of claim 43, further comprising accessing the portal and exchanging communications with members of the community.

49. The method of claim 43, wherein causing generation of the data further comprises causing generation of transactional data corresponding to a respective transaction performed by the respective user.

50. The method of claim 43, wherein causing generation of the data further comprises causing generation of the data based on a respective wireless device interaction with a respective wireless device service.

51. The method of claim 43, wherein causing generation of the data further comprises causing generation of the data operable to comprise data objects having a common object type, and further comprising causing generation of the data from multiple data sources.

52. At least one processor configured to enable participation in a community of users, comprising:
a first module for causing generation of data operable to comprise at least one data tuple, wherein each data tuple comprises respective data attributes representing user-related data and a user identifier, wherein the user-related data and the user identifier both correspond to a respective user;
a second module for receiving an indication of being a member of a community of users, wherein the indication is based on receipt of the at least one data tuple by a tuple space and discovery of a relationship between the at least one data tuple and other data tuples within the tuple space, wherein the other data tuples comprise respective data attributes representing respective user-related data and respective user identifiers corresponding to respective other users, wherein the relationship is discovered by a service tuple located within the tuple space and having a relationship determination algorithm; and
a third module for generating a response to the indication, wherein the response comprises an acceptance or a refusal to join the community of users.

53. A computer program product, comprising:
a computer readable medium, comprising:
at least one instruction for causing a computer to generate data operable to comprise at least one data tuple, wherein each data tuple comprises respective data attributes representing user-related data and a user identifier, wherein the user-related data and the user identifier both correspond to a respective user;
at least one instruction for causing the computer to receive an indication of being a member of a community of users, wherein the indication is based on receipt of the at least one data tuple by a tuple space and discovery of a relationship between the at least one data tuple and other data tuples within the tuple space, wherein the other data tuples comprise respective data attributes representing respective user-related data and respective user identifiers corresponding to respective other users, wherein the relationship is discovered by a service tuple located within the tuple space and having a relationship determination algorithm; and
at least one instruction for causing the computer to generate a response to the indication, wherein the response comprises an acceptance or a refusal to join the community of users.

54. An apparatus, comprising:
means for causing generation of data operable to comprise at least one data tuple, wherein each data tuple comprises respective data attributes representing user-related data and a user identifier, wherein the user-related data and the user identifier both correspond to a respective user;
means for receiving an indication of being a member of a community of users, wherein the indication is based on receipt of the at least one data tuple by a tuple space and discovery of a relationship between the at least one data tuple and other data tuples within the tuple space, wherein the other data tuples comprise respective data attributes representing respective user-related data and respective user identifiers corresponding to respective other users, wherein the relationship is discovered by a service tuple located within the tuple space and having a relationship determination algorithm; and
means for generating a response to the indication, wherein the response comprises an acceptance or a refusal to join the community of users.

55. A wireless device, comprising:
a processor;
a memory in communication with the processor;
a first application stored in the memory and executable by the processor, the first application comprising first application logic operable to cause generation of data operable to comprise at least one data tuple, wherein each data tuple comprises respective data attributes representing user-related data and a user identifier, wherein the user-related data and the user identifier both correspond to a respective user;
a second application stored in the memory and executable by the processor, the second application comprising second application logic operable to receive an indication of being a member of a community of users, wherein the indication is based on receipt of the at least one data tuple by a tuple space and discovery of a relationship between the at least one data tuple and other data tuples within the tuple space, wherein the other data tuples comprise respective data attributes representing respective user-related data and respective user identifiers corresponding to respective other users, wherein the relationship is discovered by a service tuple located within the tuple space and having a relationship determination algorithm; and
wherein the second application logic is further operable to generate a response to the indication, wherein the response comprises an acceptance or a refusal to join the community of users.

56. The apparatus of claim 55, wherein the second application is further operable to receive a definition of a portal operable to connect members of the community.

57. The apparatus of claim 56, wherein the second application is further operable to receive a portal-specific interactive user interface operable to connect members of the community.

58. The apparatus of claim 57, wherein the second application is further operable to receive advertising directed to the portal-specific interactive user interface.

59. The apparatus of claim 55, wherein the second application is further operable to access a user interface object within the tuple space, wherein the user interface object represents a selectable plurality of types of user interface technology operable for interaction with the community, and wherein the second application is further operable to obtain a selected one of the plurality of types of user interface technology.

60. The apparatus of claim 55, wherein the second application is further operable to access the portal and exchange communications with members of the community.

61. The apparatus of claim 55, wherein the data further comprises transactional data corresponding to a respective transaction performed by the wireless device.

62. The apparatus of claim 55, wherein the data further comprises data based on a respective wireless device interaction with a respective wireless device service.

63. The apparatus of claim 55, wherein the data corresponds to data objects having a common object type, and wherein the data is generated from multiple data sources.
